(19) United States
(12) Patent Application Publication
(10) Pub. No.: US 2009/0307113 A1
(43) Pub. Date: Dec. 10, 2009

(54) METHOD AND SYSTEM FOR DETERMINING PROFIT AND LOSS FOR SELLERS USING ONLINE AUCTIONS OR E-STORES

(76) Inventors: Richard E. Fasold, Conifer, CO (US); Peter Zibelli, Atlantis, FL (US); Joseph N. Ignat, Greenwood Village, CO (US); Mark F. DeAndrea, Wellington, FL (US)

Correspondence Address: Richard E. Fasold, 13720 Rampart Drive, Conifer, CO, 80433, US

(21) Appl. No.: 12/135,637

(22) Filed: Jun. 9, 2008

(51) Int. Cl. G06Q 10/00; G06Q 30/00; G06F 17/30

(52) U.S. Cl. 705/30

(57) ABSTRACT

A web-based method for sellers utilizing online auction and e-store sites to track their profits and losses by item or categories of items by user defined date parameters. The present invention is comprised of computer programming code that downloads the user's listing data from the auction or e-store web site and permits the users to enter their purchase cost and shipping cost in a plurality of methods. The invention produces reports that enable users to view, print and download data that show the item number, description, listing and sale dates, sales price, user cost, consignment fees (if any), auction or e-store fees, payment fees, and the user's profits. The report can be produced with item detail, sales category detail, or grand totals for a selected time period. The invention also provides the necessary calculations and reports to permit the users to engage in consignment listings.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of Invention

This invention relates to software that provides analysis and reporting for items listed for sale on online auctions or e-stores.

2. Prior Art

Over 100 million people world-wide list items for sale on online auction or e-stores web sites. These auction sites and e-stores collect various data about the listing and sale of items, such as the listing and sale dates, buyer information, sales price, listing fees and payment fees. However, there are two items necessary to calculate the profit or loss of the seller not collected: the seller's purchase cost of the item and the shipping cost incurred by the seller in delivering the item to the buyer. The profit and loss calculations are desirable to the seller to determine which categories of items are most profitable to list at an auction or e-store and in preparation of the seller's income tax return.

The prior art contains one or more of the following shortcomings:
1) The software that provides the database to perform profit and loss calculations exists only as downloadable computer software. This requires the user to have a more-than-basic knowledge of computers and to have an up-to-date computer with sufficient disk space, a modern computer processor and, typically, access to the Internet. The data stored on the user's computer is subject to hardware failures and possible loss, causing the prudent user to frequently backup his data. It also requires the user to be physically present at a particular computer, not allowing access to the data from multiple computers or hand-held computing devices. In addition, if there are changes in the methods of listing items, the user is dependent on the software provider to supply a new version of the software which must be installed by the user. Software that is web-based permits users to access their data from any Internet connected computing device. The user's data is kept on redundant disk drives and is backed up frequently. Additionally, any software changes required are made to the web based program and are available for all users without additional actions on their part.
2) Many of the prior art systems mathematically calculate fees associated with listing items. This then requires updates to the software if permanently or temporarily the fee structure changes. There is then great difficulty in associating the correct fee to the items affected. Systems that download the seller's actual fees from the auction or e-store site have no such problem, because they show the user the actual fees charged.
3) Many of the prior art systems require the user to posses specific software programs in order achieve the functionality of the system. Some of these programs are Quickbooks, Excel, Access, Sage MMS, Microsoft.net, or Framework.
4) Many of the prior art systems are provided in a manner that they can be utilized by owners of Microsoft based operating systems or Apple based operating systems, but not both systems.
5) Many of the prior art systems are complex and cumbersome, requiring lengthy user's manuals, some in excess of 100 pages.
6) Prior art systems do not provide profit and loss analysis by listing categories.

The problems of the prior art are complex and confusing software that requires above average computer skills and do not provide profit and loss analysis in the form the user needs. No prior art system overcomes the shortcomings listed above.

### SUMMARY

The present invention is a web-based Software-as-a-Service providing online auction or e-store sellers an easy way to track their profits and losses by item and by category within a user selected date range. The system is designed to be easily mastered, even permitting users to enter the purchase cost and shipping cost date directly on the report display. The system provides the necessary calculations and reports to support consignment sales.

### BRIEF DESCRIPTION OF THE DRAWINGS

The present invention is illustrated by way of example, and not by way of limitation, in the figures of the accompanying drawings in which:

FIG. 1 is the specification for a homepage of a web-based site that users and prospective users use to access the service.

FIG. 2 is the specification for a demonstration of the service including computer screen shots and a voice over narration describing the service.

FIG. 3 is the text that describes the service.

FIG. 4 is the specification for the information gathering and processing for a new user to sign up for the service.

FIG. 5 is the specification for the process of existing users to log into the service.

FIG. 6 is the specification for a bottom navigation bar available to the user for additional facts about the service.

FIG. 7 is the specification for the base page, from which the user can select the various features of the service.

FIG. 8 is the specification for the profile page, from which the user can change user-specific profile information.

FIG. 9 is the specification for the user to enter the cost of items listed on an auction or e-stores.

FIG. 10 is the specification for the user to enter the cost incurred by the user to ship sold items to the buyer of an item.

FIG. 11 is the specification for the user to select the level of detail for a report.

FIG. 12 is the specification for the user to select the date parameters for the items to be included in a report.

FIG. 13 is the specification for the user to select the status of the items to be included in a report.

FIG. 14 is the specification for the permissible additional level of item detail and entry available to the user from a report page.

FIG. 15 is the specification for the selection and content of a consignment transmittal letter.

FIG. 16 is the specification for the user to enter consignment and consignee data.

FIG. 17 is the specification for a bottom navigation bar available to the user for additional facts about the service.

FIG. 18 is the specification for a top navigation bar available to the user to move from one page to another.

### DETAILED DESCRIPTION

A method and system for storing online auction or e-store listing data, user data and consignment data in one or more databases are described. This method and system shall be called the service. The service will provide the user with profit information by item listed at an auction or e-store site, or by groups of items by date parameters. There are many auction and e-store Internet sites available to sellers. They include: amazon.com; auctionfire.com; auctionusa.com; auction.com; auctionaddict.com; auction-warehouse.com; bid-alot.com; buyselltrades.com; ebay.com; epier.com; itsgottago.com; onlineauction.com; overstock.com; penbid.com; speedbid.com; ubid.com; and, webidz.com. The service may be provided by use of a computer server which may be accessed through the Internet. The user must only have access to a computer, an Internet connection and a web browser to use the service. It will be apparent, however, to one skilled in the art that the present invention may be practiced in the art that the present invention may be practiced without these specific details.

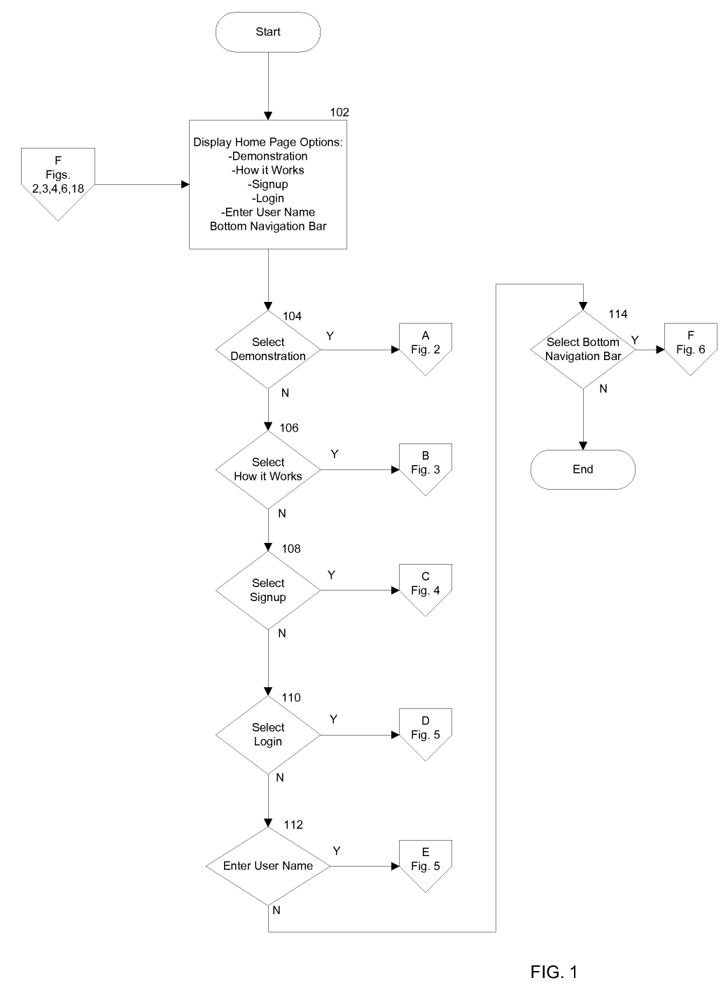

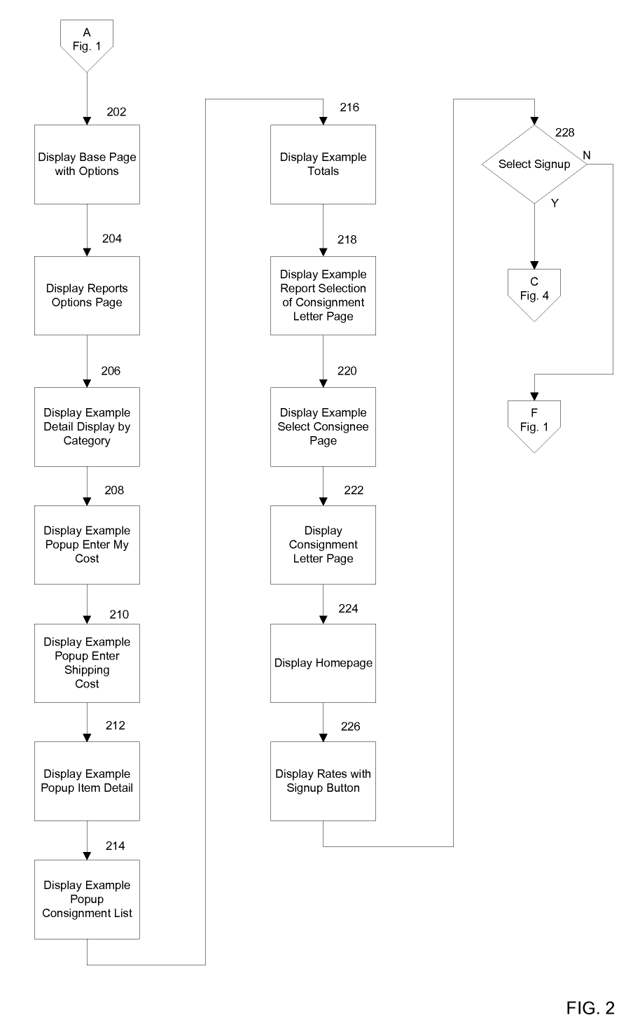

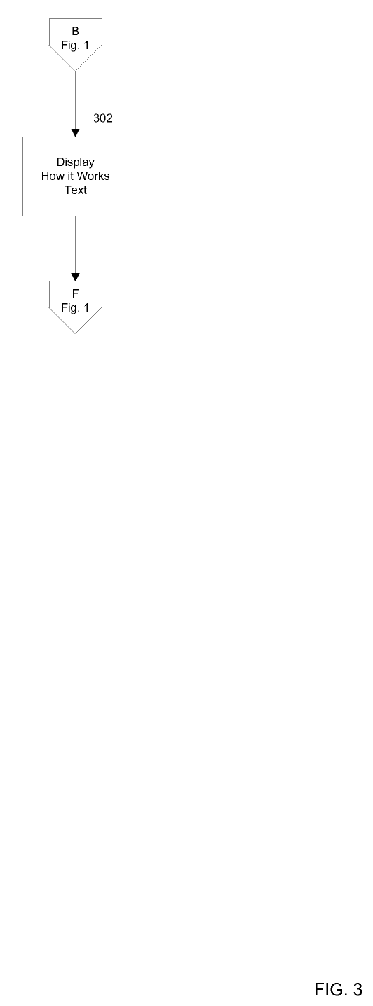

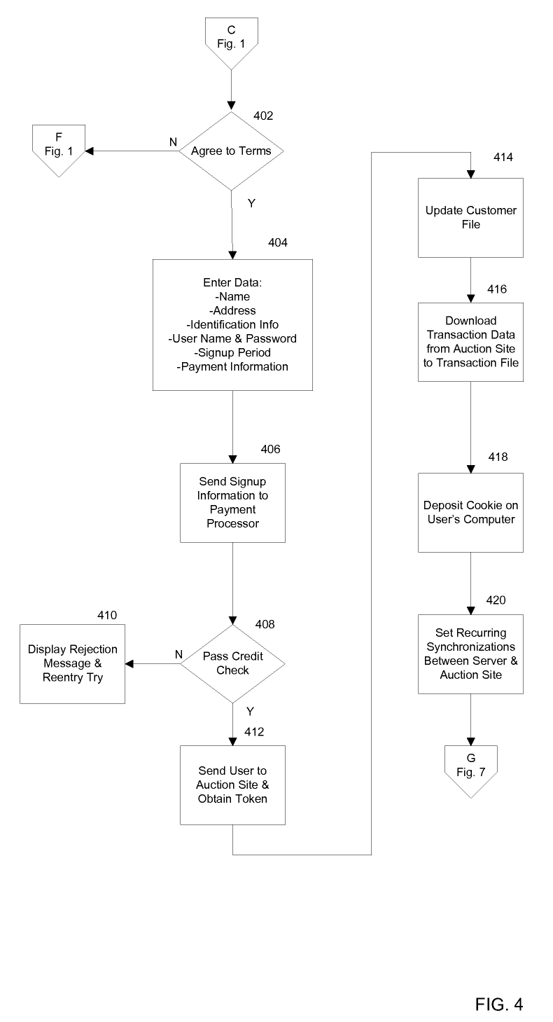

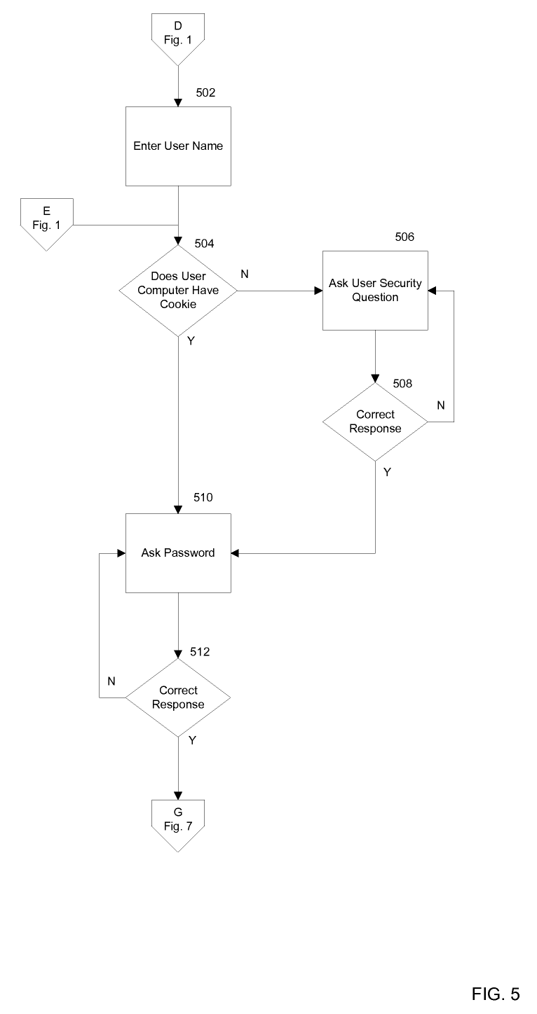

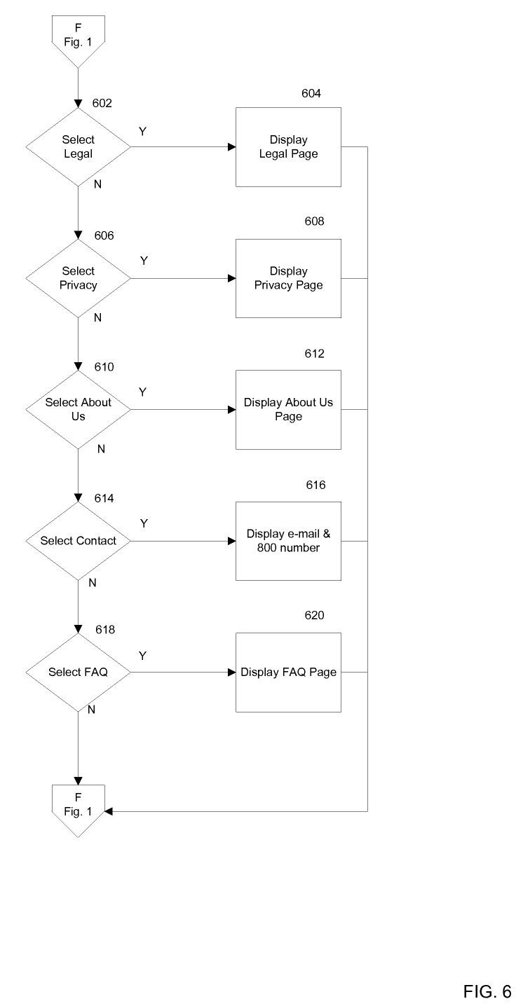

FIG. 1 describes the homepage to the web-based service through which users and potential users may access the service. A homepage 102 provides options for the user to watch a video demonstration, read how it works, sign up for the service, login for existing users, or enter user name for existing users. If the user selects demonstration 104, the user will be shown a demonstration as described in FIG. 2. If the user selects how it works 106, the user will see a popup text box that describes the service as described in FIG. 3. If the user selects signup 108, the user will directed to a new page for signup as described in FIG. 4. If the user selects login 110, the user will be directed to a login page as described in FIG. 5. If the user enters the user name in an entry space 112, the user will be directed to a login page as described in FIG. 5. Available to the user will be a bottom navigation bar 114, which provides the user with additional information about the service as described in FIG. 6.

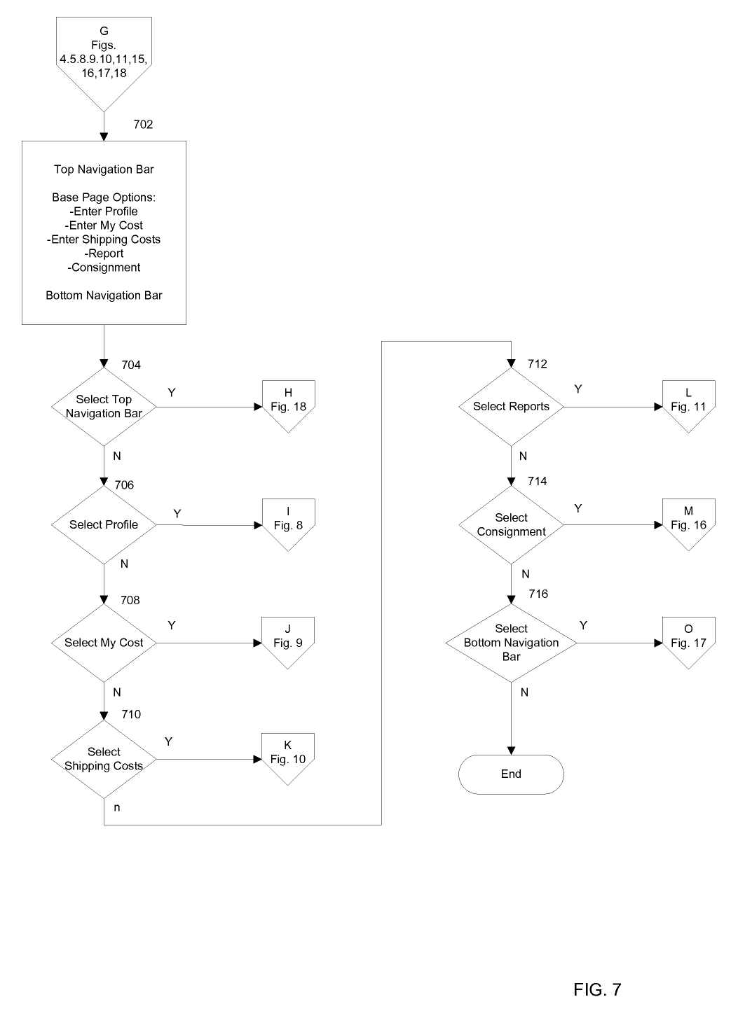

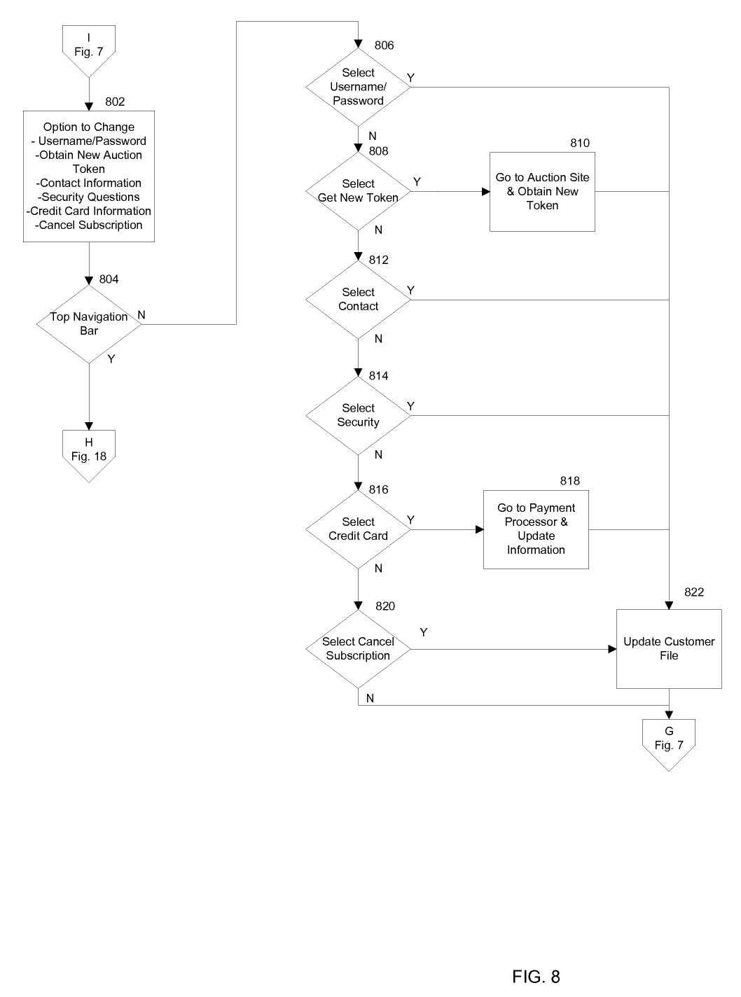

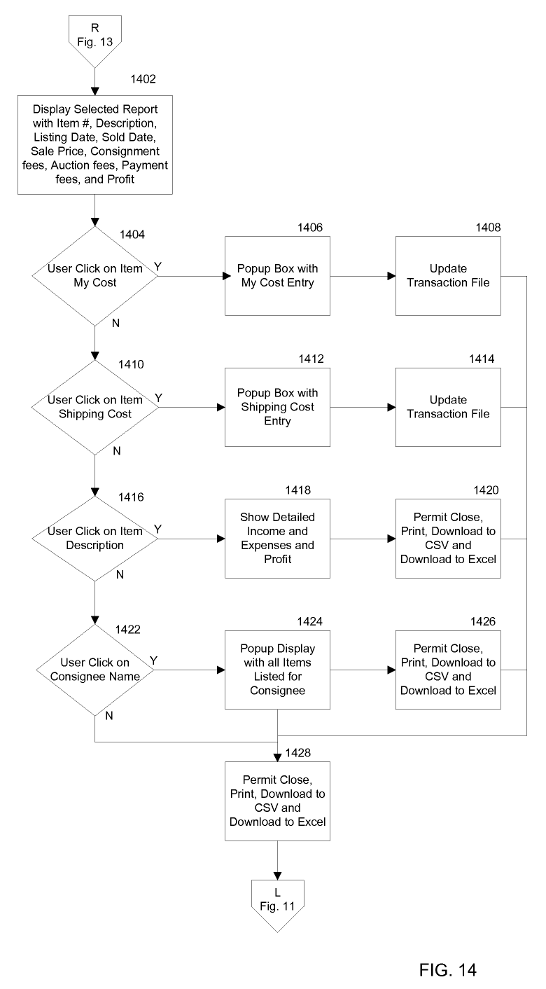

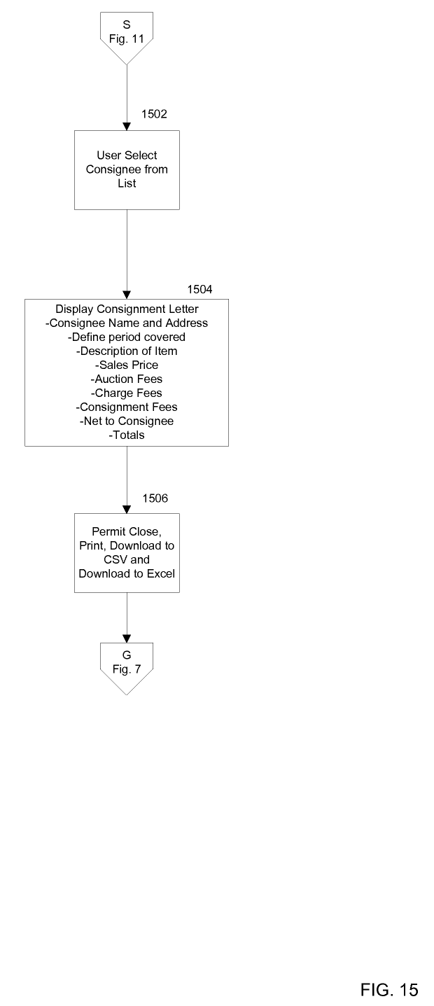

FIG. 2 describes the demonstration movie. The first scene shows a base page 202 and described in FIG. 7. The video demonstration movie describes the options available on the base page to the user: profile, my cost, shipping cost, reports, and consignment. The next scene shows the report selection options page 204 and described in FIGS. 8, 11, 12, and 13. The scene describes the options available to the user: level of detail, the date parameters and the auction or e-store items to be shown. The next scene shows the user an example report page with detail display by category 206 and described in FIG. 14. The next scene shows an example of a popup entry for the user to enter the price the user paid, my cost, for the listed item 208 and described in FIG. 14. The next scene shows the user an example of a popup entry for the user to enter the cost the user paid for shipping 210 and described in FIG. 14. The next scene shows an example of the item listing detail, including sales price, cost, shipping cost, shipping paid by buyer, itemized auction or e-store listing fees, and payment fees, when the item description is clicked by the user 212 and described in FIG. 14. The next scene shows the user an example of the popup screen of all items listed for an individual consignee when the consignee name is clicked 214 and described in FIG. 14. The next scene shows the user the totals at the bottom of the report page 216. The next scene shows the user the selection of the parameters for a consignee transmittal letter on the report selection page 218. The next scene shows the user the selection of an individual consignee 220 and described in FIG. 15. The next scene shows the user an example of a consignee transmittal letter including consignee name and address, the period covered, item description, the sales price, auction or e-store fees, charge fees, consignment fees, a net amount paid to the consignee and totals 222 and described in FIG. 15. The next scene shows the user the homepage and discusses security features of the service 224. The next scene shows the user the rates for the service and gives the option to go directly to the signup page 226. The user is then permitted to signup or close the demonstration 228. If the user selects signup, the user is directed to the signup page FIG. 4. If the user selects close, the user is returned to the homepage FIG. 1.

FIG. 3 shows the how it works page. How it works describes the features of the service in text 302.

FIG. 4 describes the signup process. The user is shown Terms and Conditions for the use of the service and given a choice to accept or decline 402. If the user declines, the user is directed to the homepage FIG. 1. If the user accepts, the user is shown an input page for entering name, address, security information, establish a user name and password, the subscription period and payment information 404. The user's payment information is sent to a third party payment processor for authorization 406. The third party payment processor returns validation information 408. If the user is rejected, the user is given another chance to enter the user's payment information again 410. If the user is validated, the user is transferred to the auction ore e-store web site to obtain a token 412. A token is a code that permits a third party to access data from an auction or e-store site relating to the user's listing data. The user database is updated with the user's name, address, user name, security information, signup period and auction or e-store token 414. Using the token, the user's auction or e-store listing data is downloaded and posted to the transaction file 416. A cookie is deposited on the user's computer 418. At a later time, when the user signs in, the cookie is checked by the service. If there is no cookie on the user's computer, one of three security questions is asked of the user FIG. 5. If there is a cookie on the user's computer, the security question is not asked. A recurring (several times in a 24 hour period) synchronization between the service computer server and the auction or e-store site is established to update the transaction file with the user's new listings 420. With a successful signup, the user is directed to the base page.

FIG. 5 describes the sign in process. If on the homepage the user clicks login, the user is request to enter the user name 502. If the user entered the user name on homepage, the cookie presence is checked 504. If the cookie is not detected, the user is asked one of the security questions selected at signup 506. If the user does not give the correct response, the user is directed to reenter a security answer. If the user gives the correct response, the user is asked for a password 510. If the user does not give the correct response, the user is directed to reenter the password. If the user gives the correct response, the user is directed to the base page FIG. 7.

FIG. 6 describes the bottom navigation bar. If the user selects legal 602, the user is shown a popup box with text describing the legal terms of use of the service 604. If the user selects privacy 606, the user is shown a popup box with text describing the privacy terms of user of the service 608. If the user selects about us 610, the user is shown a popup box with text describing the providers of the service 612. If the user selects contact 614, the user is shown a popup box with text showing the email address and 800 number of the service 616. If the user selects FAQ 618, the user is shown a popup box with text describing the frequently asked questions and answers regarding the service 620.

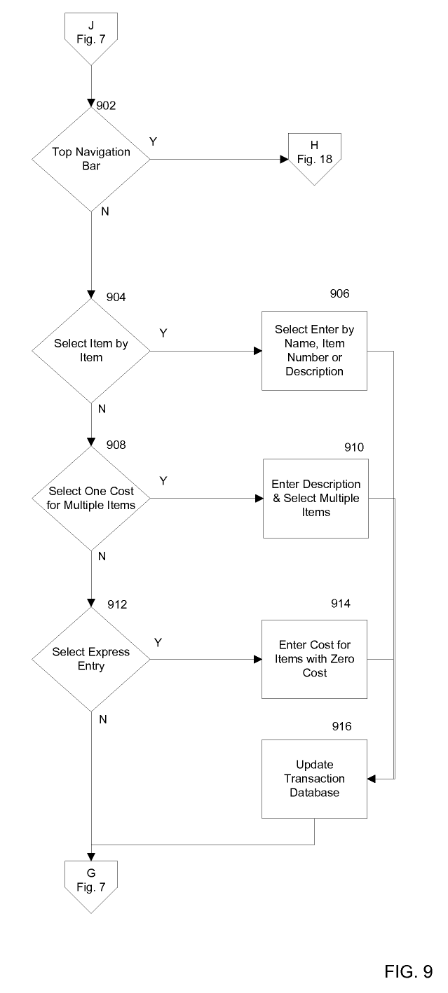

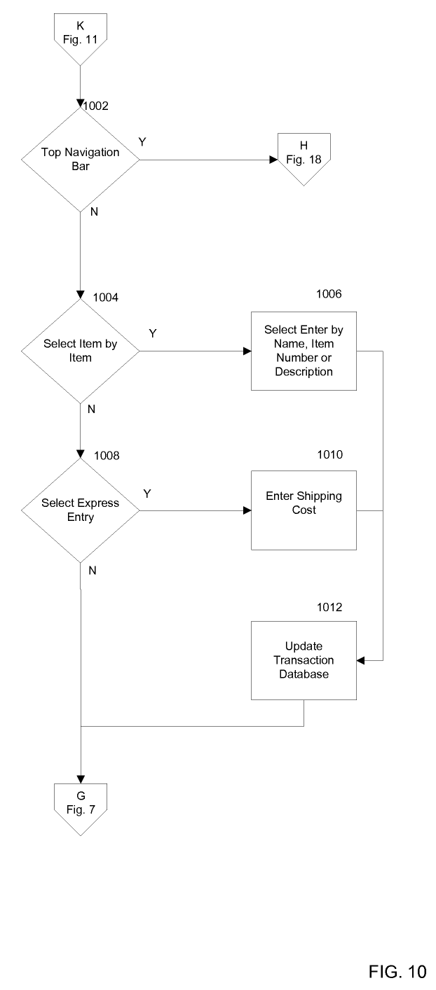

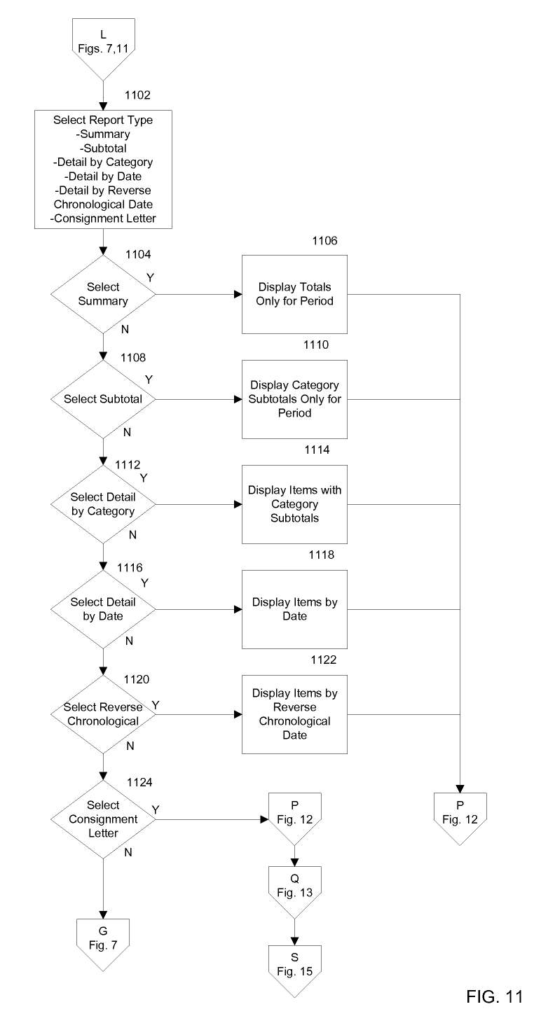

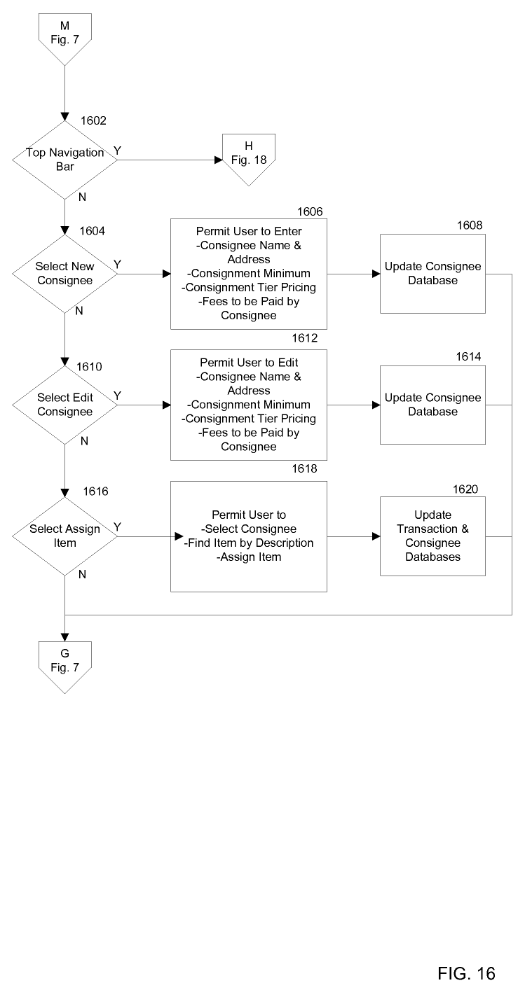

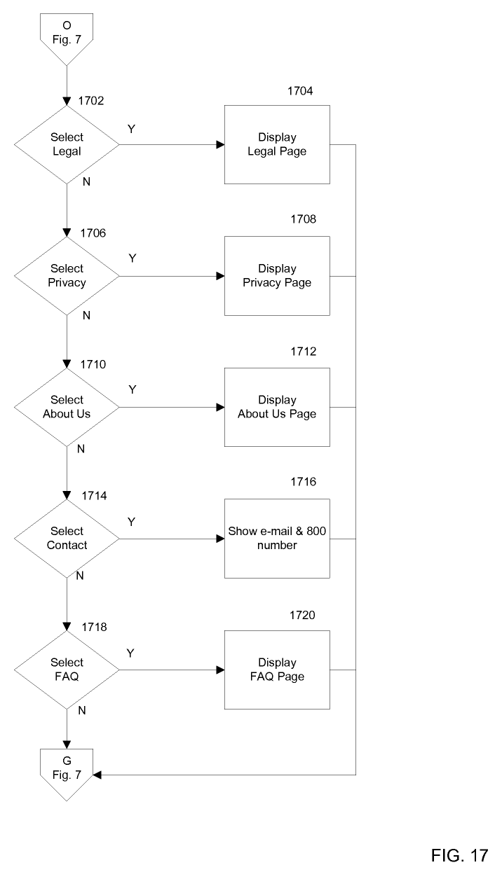

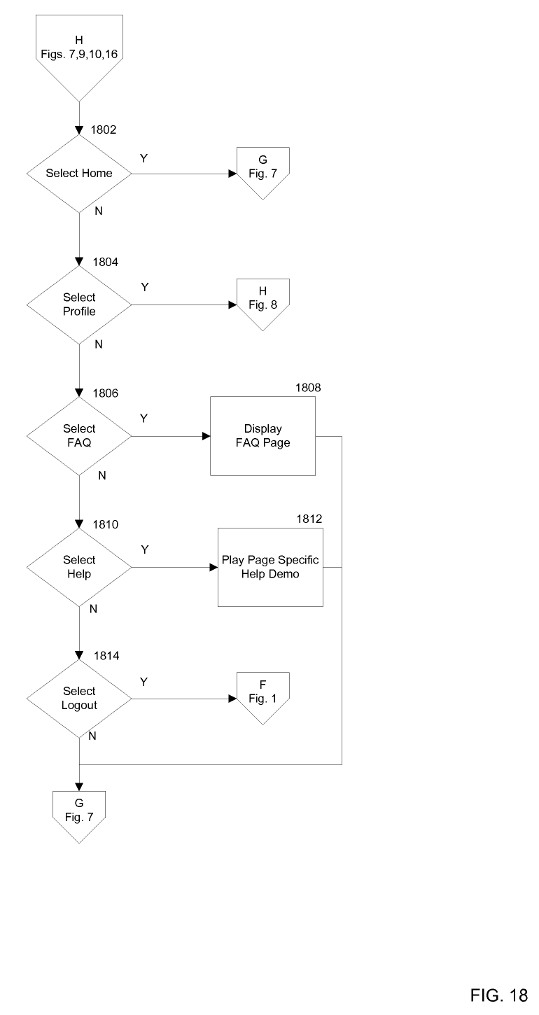

FIG. 7 describes the base page showing: the top navigation bar, profile, my cost, shipping costs, reports, consignment and bottom navigation bar 702. If the user selects an item on the top navigation bar 704, the user will be directed to a page as described in FIG. 18. If the user selects profile 706, the user will be directed to a page as described in FIG. 8. If the user selects my cost 708, the user will be directed to a page as described in FIG. 9. If the user selects shipping costs 710, the user will be directed to a page as described in FIG. 10. If the user selects reports 712, the user will be directed to a page as described in FIG. 11. If the user selects consignment 714, the user will be directed to a page as described in FIG. 16. If the user selects an item on the bottom navigation bar 716, the user will be directed to a page as described in FIG. 17.

FIG. 8 describes the profile page. If the user selects an item on the top navigation bar 802, the user will be directed to a page as described in FIG. 18. The profile page shows the options to change: user name, password, auction or e-store token, contact information, security questions and responses, payment information and cancel subscription 804. If the user selects username/password and enters new information 806, the customer database is updated with the new information 822. If the user selects get a new token 808, the user is directed to the auction or e-store site to obtain a new token 810 and the customer database is updated 822. If the user selects contact information and enters new information 812, the customer database is updated with the new information 822. If the user selects security and enters new information 814, the customer database is updated with the new information 822. If the user selects credit card 816, the third party payment site is updated with the new information 818 and the customer database is updated 822. If the user selects cancel my subscription 820, the customer database is updated with the cancellation 822 and the user will not be permitted access to the service.

FIG. 9 describes the my cost page. If the user selects an item on the top navigation bar 902, the user will be directed to a page as described in FIG. 18. If the user selects item by item 904, the user may select an item by name, item number or description and enter the purchase cost data 906. The transaction database is then updated with the new information 916. If the user selects one cost for multiple items 908, the user may enter the description of the items to select and enter one price that is pro rated among the items selected 910. The transaction database is then updated with the new information 916. If the user selects express entry 912, the user will be presented a page with all items that do not have a purchase price and the user may enter one or more purchase price(s) 914. The transaction database is then updated with the new information 916.

FIG. 10 describes the shipping cost page. If the user selects an item on the top navigation bar 1002, the user will be directed to a page as described in FIG. 18. If the user selects item by item 1004, the user may select an item by name, item number or description and enter the shipping cost paid by the user 1006. The transaction database is then updated with the new information 1012. If the user selects express entry 1008, the user will be presented a page with all items that do not have shipping costs and the user may enter one or more shipping cost(s) 1010. The transaction database is then updated with the new information 1012.

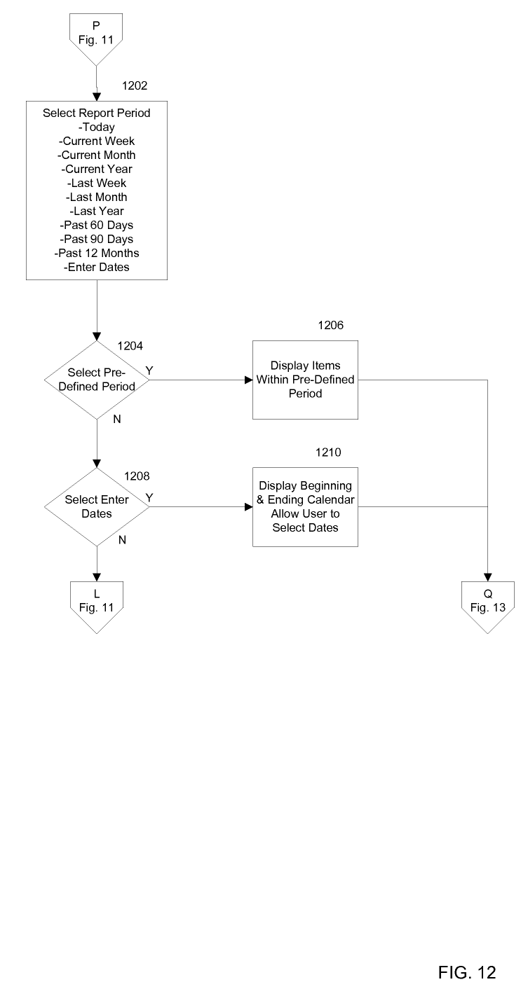

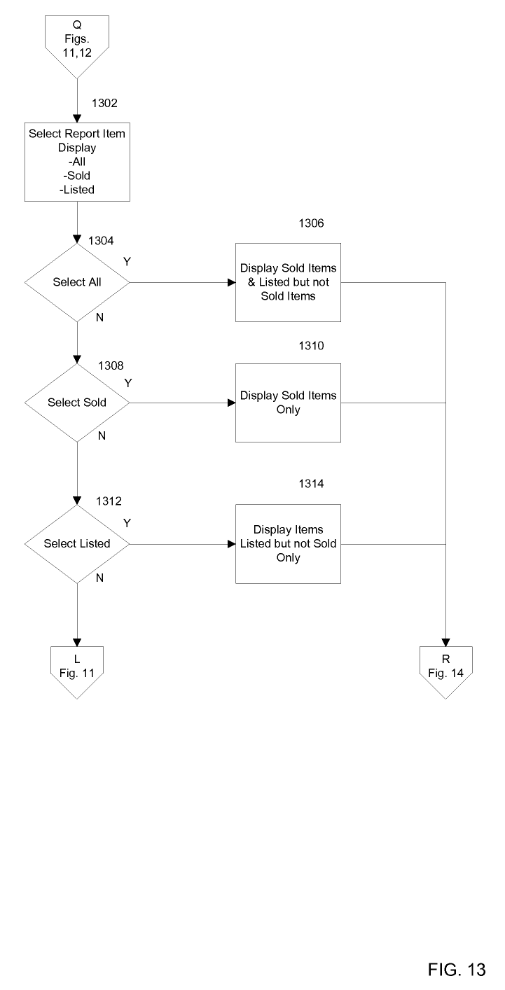

FIG. 11 describes the select report type function. The user is presented with a dropdown menu to select report type: summary, subtotal, detail by category, detail by date, detail by reverse chronological order, and consignment letter 1102. If the user selects summary 1104, the report displays only totals for the period selected 1106. If the user selects subtotal 1108, the report displays subtotals by auction or e-store categories for the period selected 1110. If the user selects detail by category 1112, the report displays only item details with subtotals by auction or e-store category for the period selected 1114. If the user selects detail by date 1116, the report displays items in listing date order for the period selected 1118. If the user selects reverse chronological order 1120, the report displays items listed in reverse chronological date listing date order for the period selected 1122. If the user selects consignment letter 1124, the consignee letter is generated using the report period selected as described in FIG. 12 and the item display selected as described in FIG. 13 and the letter displayed as described in FIG. 15.

FIG. 12 describes the select report period function. The user is presented with a dropdown menu to select report period: today, current week, current month, current year, last week, last month, last year, past 60 days, past 90 days, past 12 months, and enter custom dates 1202. If the user selects a pre-defined period 1204, a report will be generated with items shown from the pre-defined period 1206. If the user selects enter dates 1208, the user is presented with two calendars, one from which the user may click the beginning date for the report, and one from which the user may click the ending date for the report 1210.

FIG. 13 describes the item display report function. The user is presented with a dropdown menu to select the items to be displayed: all, display sold items and items listed but not sold, display only sold items, and display items listed but not sold 1302. If the user selects all 1304, the report displays items sold and items listed but not sold 1306. If the user selects sold 1308, the report displays only items sold 1310. If the user selects listed 1312, the report displays only items listed but not sold 1314.

FIG. 14 describes the report display. The report presented to the user shows the user name, the period covered with columns showing: item number, description, listing date, sold date, sale price, consignment fees, auction or e-store fees, payment fees and profit 1402. There are several links that when clicked, the user is presented popup boxes that enable the user to view detailed information or enter data into the database directly from the report. If a user clicks on an amount in an item's my cost column 1404, the user is presented with a popup box that permits the entry or edit of the item's cost to the user 1406 and after the entry, the transaction file is updated 1408. If a user clicks on a shipping cost in an item's shipping cost column 1410, the user is presented with a popup box that permits the entry or edit of the item's shipping cost paid by the user 1412 and after the entry, the transaction file is updated 1414. If the user clicks on an item's description 1416, a popup box is presented to the user that shows item details: item number, description, number of items listed, user's cost, sale price, itemized auction or e-store listing and sale fees, payment fees, total income and expense, profit for the item and the gross sales margin 1418. The user is permitted to download the information to a CSV file, and Excel file, print or close the popup box 1420. If the user clicks on an item's consignee name (consigned items appear with the consignee name under the item number) 1422, a popup box is presented to the user that shows all items listed for consignee selected 1424. The user is permitted to download the information to a CSV file, and Excel file, print or close the popup box 1426. At the bottom of the report page, the user is permitted to download the information to a CSV file, and Excel file, print or close the popup box 1428.

FIG. 15 describes the consignee transmittal letter selection and display. From the selections made described in FIG. 11, the user is presented with a dropdown menu with all user consignees from which the user selects a consignee 1502. A consignee transmittal letter is display showing: the consignee name and address, the period covered, description of the item(s), sales price(s), auction or e-store fee(s), payment fee(s), consignment fee(s), the net paid to consignee and totals 1504. At the bottom of the consignee transmittal letter, the user is permitted to download the information to a CSV file, and Excel file, print or close the transmittal letter 1506.

FIG. 16 describes the consignee data entry page. If the user selects an item on the top navigation bar 1602, the user will be directed to a page as described in FIG. 18. If the user selects new consignee 1604, the user is shown an entry screen for a new consignee 1606 with entry for: name and address, consignment minimum fee charged each item, consignment tiered pricing and the auction or e-store fees and payment fees to be charged to the consignee. Tiered commission pricing is varying percentages times the sales price for different sale price ranges. For example, if the sale price is between $0.00 and $500.00 the commission percentage charged is 38%. If the sales price is between $500.00 and $1,000.00 the commission percentage charged is 25%, and so on. Thus, if an item sold for $300.00, the commission would be $114.00 (300.00 times 38%). If an item is sold for $800.00, the commission would be $265.00 (500.00 times 38% plus 300.00 times 25%). When the user completes the input, the consignment database is updated 1606.

If the user selects edit consignee, the user is shown the existing consignee data 1610. The user is permitted to change any of the consignee data 1612. When the user completed the changes, the consignment database is updated 1614.

If the user selects assign an item 1616, the user is permitted to associate an auction or e-store listing with an individual consignee. The user is permitted to select the consignee name then select one or more auction or e-store listings by description and associate the listing with the consignee 1618. When the user completes the association, the transaction database and the consignment database are updated 1620.

FIG. 17 describes the bottom navigation bar. If the user selects legal 1702, the user is shown a popup box with text describing the legal terms of use of the service 1704. If the user selects privacy 1706, the user is shown a popup box with text describing the privacy terms of use of the service 1708. If the user selects about us 1710, the user is shown a popup box with text describing the providers of the service 1712. If the user selects contact 1714, the user is shown a popup box with text showing the email address and 800 number of the service 1716. If the user selects FAQ 1718, the user is shown a popup box with text describing the frequently asked questions regarding the service 1720.

FIG. 18 describes the top navigation bar. If the user selects home, the user will be directed to the base page 1802 as described in FIG. 7. If the user selects profile, the user will be directed to the profile page 1804 as described in FIG. 8. If the user selects FAQ 1806, a popup display will show the user frequently asked questions and answers 1808. If the user selects help 1810, a popup video with screen shots and voice over will play 1812. The video will be custom made for each screen that has the top navigation bar.

We claim:

1. A method for determining profit and loss for sellers on online auctions or e-stores including a client computer system accessible for online interactive communication with users, said client computer system comprising:
a. a item database for storing items listed for sale by a user;
b. a user database for storing said user's profile data;
c. establishing an online link to an online auction or e-store, and electronically downloading said user's listing data;
d. a means for said user to enter in the said item database an item purchase cost;
e. a means for said user to enter in the said item database an item shipping expense; and,
f. displaying income, expense and profit data to said user.

2. The computer system of claim 1, wherein said computer is programmed to permit users to modify said profile data.

3. The computer system of claim 1, wherein said computer is programmed to download said user's listing data using a user code.

4. The computer system of claim 1, wherein said computer is further programmed to provide said user with a system to calculate income and expenses incurred when said user lists an item for sale on an online auction or e-store under consignment with steps comprising:
a. a means for said user to enter and modify a consignee's profile data;
b. a means for said user to enter and modify the terms of the consignment, including minimum consignment fee, and tiered commission fees;
c. a means for said user to designate auction or e-store fees and purchase fees to be paid by said consignee;
d. a report that displays all items listed for said consignee; and,
e. a report that displays a transmittal letter to said consignee, providing income, expense, and net payment to said consignee.

5. The computer system of claim 1, wherein said computer is further programmed to provide said user with reports, with steps providing:
a. a means for said user to select the grouping of said user's items for a period of time, including grand totals, subtotals by item categories, individual items subtotaled by category, individual items in chronological order, and individual items in reverse chronological order;
b. a means for said user to select the status of said user's items to be displayed, including only items sold, items listed but not sold, and all items;
c. a means for said user to select to display further detail of said user's items income and expense;
d. a means for said user to display all items listed for said consignee;
e. a means for said user to download the displayed report to said user's computer in a CSV format;
f. a means for said user to download the displayed report to said user's computer in Excel format; and,
g. a means for said user to print the displayed report to said user's printer.

6. The computer system of claim 1, wherein said computer is further programmed to provide said user a display of frequently asked questions and answers.

7. The computer system of claim 1, wherein said computer is further programmed to provide said user a help demonstration video custom designed for each displayed page.

8. The computer system of claim 1, wherein said computer is further programmed to provide a prospective user to become a subscriber to said computer system, with steps providing:
a. a means for entering said prospective user's profile data;
b. a means for entering said prospective user's security information;
c. a means for said prospective user to obtain said prospective user's online auction or e-store entry code; and,
d. a means for entering the prospective user's payment information.

9. The computer system of claim 1, wherein said computer is further programmed to provide said prospective user a demonstration video of the features of said computer system.

10. A method and system to permit users viewing a displayed report on a monitor of a computer to enter data directly into an associated database.

11. A computer system of claim 9, wherein sellers on online auctions or e-stores including a client computer system accessible for online interactive communication with users, are permitted to enter on said displayed report the said seller's item purchase cost.

12. A computer system of claim 9, wherein sellers on online auctions or e-stores including a client computer system accessible for online interactive communication with users, are permitted to enter on said displayed report the said seller's item shipping expense.

13. A method and system to permit users viewing a displayed main report on a monitor of a computer to select to view a computer displayed secondary report that provides further detail for the information displayed on said main report.
